(19) United States
(12) Patent Application Publication
(10) Pub. No.: US 2024/0161097 A1
(43) Pub. Date: May 16, 2024

(54) Transaction Authentication

(71) Applicant: Google LLC, Mountain View, CA (US)

(72) Inventors: Ankit Aggarwal, Singapore (SG); Sakshi Gopal, Singapore (SG); John J. Geewax, JR., Singapore (SG); Jia Lin Cai, Singapore (SG); Ishaan Malhi, Singapore (SG)

(21) Appl. No.: 18/510,183

(22) Filed: Nov. 15, 2023

(30) Foreign Application Priority Data
Nov. 15, 2022 (IN) 202221065324

(51) Int. Cl. G06Q 20/38; G06Q 20/40

(52) U.S. Cl. CPC G06Q 20/3825; G06Q 20/38215; G06Q 20/4016

(57) ABSTRACT

A method for authenticating a transaction between two entities includes receiving, by one or more processors, a request associated with the transaction between a first entity associated with a first computing device and a second entity, generating, by the one or more processors, transaction details information associated with completion of the transaction between the first entity and the second entity, encrypting, by the one or more processors, the transaction details information by digitally signing the transaction details information, and transmitting, by the one or more processors, the transaction details information encrypted by the one or more processors, to the first computing device.

### PRIORITY CLAIM

This application is based on and claims priority to India Provisional Application No. 202221065324 having a filing date of Nov. 15, 2022, which is incorporated by reference herein in its entirety for all purposes.

### FIELD

The disclosure relates generally to authenticating transactions. For example, the disclosure relates to computer implemented methods and computer systems for authenticating transactions using digitally signed transaction details information which may be embedded in a barcode.

### BACKGROUND

With the rise of online instant payments through mobile device applications, there is also a rise in fraud vectors that leverage this relatively new medium of paying, especially in less developed or secure markets. As an example, a customer obtains an item from a merchant and pretends to pay via a payment app. The customer then shows the merchant a fake display screen on their mobile device which appears to provide confirmation of payment, and the customer leaves with the supposedly purchased item. As a variation of the above example, the customer may also show the merchant a fake display screen on their mobile device which appears to provide confirmation of payment which “accidentally” exceeded the purchase price. The customer then requests and receives a refund for the supposed excess payment. The merchant believes they have received payment (or that a payment will arrive shortly after) but in fact they have not been, nor will they ever be, paid.

### SUMMARY

Aspects and advantages of embodiments of the disclosure will be set forth in part in the following description, or can be learned from the description, or can be learned through practice of the example embodiments.

In one or more example embodiments, a computer implemented method for authentication of a barcode associated with a transaction is provided. For example, the method includes receiving, by one or more processors, a request associated with a transaction between a first entity and a second entity; generating, by the one or more processors, transaction details information associated with completion of the transaction via a first computing device associated with the first entity; encrypting, by the one or more processors, the transaction details information by digitally signing the transaction details information; and transmitting, by the one or more processors, the transaction details information encrypted by the one or more processors, to the first computing device.

In some implementations, the transaction details information includes at least one of a transaction time, first entity information, second entity information, a unique identifier associated with the second entity, status information, or an amount of the transaction.

In some implementations, the method may include embedding, by the one or more processors, the transaction details information encrypted by the one or more processors, in a barcode; and transmitting, by the one or more processors, the barcode including the transaction details information encrypted by the one or more processors and embedded in the barcode, to the first computing device.

In some implementations, the barcode corresponds to a quick response code.

In some implementations, the method further includes receiving, by the one or more processors, a request to determine whether a barcode displayed on the first computing device is associated with the transaction and is authentic; and authenticating the transaction by decrypting the transaction details information encrypted by the one or more processors, wherein the transaction details information is embedded in the barcode.

In some implementations, the method further includes providing a first notification indicating the barcode is not authentic when a first hash value calculated based on the transaction details information is not equal to a second hash value calculated based on a digital signature used to digitally sign the transaction details information; and providing a second notification indicating the barcode is authentic when the first hash value calculated based on the transaction details information is equal to the second hash value calculated based on the digital signature used to digitally sign the transaction details information.

In one or more example embodiments, a computing device is provided. The computing device may include a first computing device, comprising: a display device; at least one memory to store instructions; and at least one processor configured to execute the instructions to perform operations, the operations comprising: capturing an image of a barcode provided on a display of a second computing device, wherein the barcode is potentially associated with a transaction between a first entity associated with the first computing device and a second entity associated with the second computing device, determining whether the barcode is authentic based on a decryption of encrypted transaction details information embedded in the barcode and a determination of whether a first hash value calculated based on the transaction details information is equal to a second hash value calculated based on a digital signature used to digitally sign the transaction details information, providing, for display on the display device, a first notification indicating the barcode is not authentic when determining the barcode is not authentic, and providing, for display on the display device, a second notification indicating the barcode is authentic when determining the barcode is authentic.

In some implementations, the transaction details information includes at least one of a transaction time, first entity information, second entity information, a unique identifier associated with the first entity, status information, or an amount of the transaction.

In some implementations, the operations further comprise decrypting the encrypted transaction details information embedded in the barcode without an internet connection.

In some implementations, wherein the barcode corresponds to a quick response code.

In some implementations, decrypting the encrypted transaction details information embedded in the barcode without the internet connection includes decrypting the digital signature using a public key stored at the first computing device.

In some implementations, the operations further comprise: transmitting, to a server computing system, the image of the barcode, and determining whether the barcode is authentic includes: receiving, from the server computing system, a first indication that the barcode is not authentic when the server computing system determines the first hash value is not equal to the second hash value, and receiving, from the server computing system, a second indication that the barcode is authentic when the server computing system determines the first hash value is equal to the second hash value.

In some implementations, the barcode corresponds to a quick response code.

In some implementations, a uniform resource locator is embedded in the barcode, and transmitting, to the server computing system, the image of the barcode is in response to capturing an image of the uniform resource locator embedded in the barcode.

In one or more example embodiments, a computing system is provided. The computing system may include a first computing device, including: a first display device, at least one first memory to store instructions, and at least one first processor configured to execute the instructions stored in the at least one first memory to perform operations, the operations comprising: transmitting, to a server computing system, a request associated with a transaction between a first entity associated with the first computing device and a second entity, receiving, from the server computing system, a barcode including encrypted transaction details information embedded in the barcode, the transaction details information being associated with completion of the transaction between the first entity and the second entity, providing, for display by the first display device, the barcode and at least a portion of the transaction details information including one or more of a transaction time, first entity information, second entity information, a unique identifier associated with the second entity, status information, or an amount of the transaction.

In some implementations, the computing system further comprises a second computing device with which the second entity is associated, the second computing device including: a second display device; at least one second memory to store instructions; and at least one second processor configured to execute the instructions stored in the at least one second memory to perform operations, the operations comprising: capturing an image of the barcode provided for display by the first display device, determining whether the barcode is authentic based on a decryption of the encrypted transaction details information embedded in the barcode, providing, for display by the second display device, a first notification indicating the barcode is not authentic when a first hash value calculated based on the transaction details information is not equal to a second hash value calculated based on a digital signature used to digitally sign the transaction details information, and providing, for display by the second display device, a second notification indicating the barcode is authentic when the first hash value calculated based on the transaction details information is equal to the second hash value calculated based on the digital signature used to digitally sign the transaction details information.

In some implementations, the barcode corresponds to a quick response code, and the operations of the at least one second processor further comprise decrypting the encrypted transaction details information embedded in the barcode without an internet connection.

In some implementations, decrypting the encrypted transaction details information embedded in the barcode without the internet connection includes decrypting the digital signature using a public key stored at the second computing device.

In some implementations, the barcode corresponds to a quick response code, and the operations of the at least one second processor further comprise: transmitting, to the server computing system, the image of the barcode, and receiving, from the server computing system, a first indication that the barcode is not authentic when the server computing system determines the first hash value is not equal to the second hash value, and receiving, from the server computing system, a second indication that the barcode is authentic when the server computing system determines the first hash value is equal to the second hash value.

In some implementations, a uniform resource locator is provided for display by the first display device separately from the barcode, and transmitting, to the server computing system, the image of the barcode is in response to capturing an image of the uniform resource locator.

In one or more example embodiments, a computing system (e.g., a computing device, a server computing system, or combinations thereof) for speech recognition is provided. The computing system may include the speech recognition system and a functional system configured to execute one or more operations of the computing system in response to a matching score between the second speech recognition result and the one or more terms from the plurality of terms exceeding a threshold matching level.

In some implementations, the operations further include: determining respective matching scores between a first term from the plurality of terms included in the first voice input and each candidate term corresponding to the first term, and providing a prompt requesting at least one of contextual information relating to the first term or confirmation information relating to each candidate term corresponding to the first term, in response to determining none of the respective matching scores exceed a threshold matching level or in response to determining a plurality of the respective matching scores exceed the threshold matching level.

In one or more example embodiments, a computer-readable medium (e.g., a non-transitory computer-readable medium) which stores instructions that are executable by one or more processors of a computing system is provided. In some implementations the computer-readable medium stores instructions which may include instructions to cause the one or more processors to perform one or more operations of any of the methods described herein (e.g., operations of the server computing system and/or operations of the computing device). The computer-readable medium may store additional instructions to execute other aspects of the server computing system and computing device and corresponding methods of operation, as described herein.

These and other features, aspects, and advantages of various embodiments of the disclosure will become better understood with reference to the following description, drawings, and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of example embodiments directed to one of ordinary skill in the art is set forth in the specification, which makes reference to the appended drawings, in which:

FIG. 1 depicts an example transaction environment according to one or more example embodiments of the disclosure;

FIG. 2 depicts an example system according to one or more example embodiments of the disclosure;

FIG. 3 depicts example block diagrams of first and second computing devices and the server computing system, according to one or more example embodiments of the disclosure;

FIG. 4 and FIGS. 5A-5B depict example user interface screens of computing devices which may be provided when authenticating a transaction between a first entity and a second entity, according to one or more examples of the disclosure;

FIGS. 6A-6C depict example processes for verifying or authenticating a transaction between a first entity and a second entity, according to one or more examples of the disclosure;

FIGS. 7A-7B depict examples of programming syntax for defining messages regarding generating strings for transaction details information and for a digital signature, according to one or more examples of the disclosure; and

FIGS. 8A-8B depict example processes for verifying or authenticating a transaction between a first entity and a second entity, according to one or more examples of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

Examples of the disclosure are directed to a computer-implemented transaction authentication method and transaction authentication system for authenticating transactions between a first entity (alternatively referred to as a consumer, buyer, or payor, herein) associated with a first computing device and a second entity (alternatively referred to as a merchant, seller, or payee, herein) associated with a second computing device. The transaction authentication method allows the second computing device to accurately verify various details of a transaction in an expedient manner, which may be conducted in an offline or online manner.

In some circumstances a lag may exist between the time of payment completion by a consumer and the merchant obtaining confirmation or notification of the payment. For example, a stable internet connection may not be available and if the merchant is offline or is experiencing a poor internet connection, there may be no method for the merchant to proactively verify the transaction without receiving the confirmation or notification from the server computing system. As another example, the server computing system may also be experiencing service disruptions which can cause the confirmation or notification from the server computing system to not be sent to the merchant or to be delayed.

Scammers take advantage of the lag in the time it takes for confirmation or notification of payment. For example, the merchant may rely on the word of the buyer or be fooled by a fake screenshot of a transaction because the merchant has no way of knowing a transaction is completed until the confirmation or notification of payment is actually received by the merchant. In some cases, the actual merchant registered and receiving payment confirmation or notification may not be available at the store and the staff has no option but to trust the screenshot of the transaction shown to them, which can accurately imitate genuine transaction details and be generated using applications available in the marketplace. Thus, merchants have a fundamental problem of not being able to quickly or accurately validate transaction screenshots presented to the merchant.

According to example embodiments a transaction authentication system may include a transaction authentication application which provides a secure way for a merchant to verify (both in an offline and online manner) the authenticity of a transaction using digitally signed barcodes. Offline verification capabilities of the transaction authentication system remove the dependency for transaction authentication on the availability of the internet.

In some implementations, the transaction authentication application may be configured to actively alert the merchant if the transaction is not valid (e.g., by displaying a warning message, sounding an alarm, etc.). In some implementations, the transaction authentication application may be configured to display a recency of the transaction (e.g., a time that the payment occurred) as part of a verification user interface screen to prevent or discourage scammers from reusing old transaction details pages. In some implementations, the transaction authentication application may be configured to keep track of the number of times a transaction has been authenticated as part of a verification user interface screen to prevent or discourage scammers from reusing old transaction details pages.

According to example embodiments, when a buyer purchases a good or service from a merchant via a payment or transaction application, the payment or transaction application may include a transaction details page (i.e., the electronic receipt) which includes a barcode (e.g., a quick response (QR) code) that contains digitally signed transaction details information. The merchant may use a computing device to scan the barcode shown on the transaction details page (either in an offline or online manner) to validate the transaction. In some implementations the transaction details may include one or more of the merchant name, the buyer name, a time stamp, an amount, a transaction identifier, and a status. The transaction authentication system may be configured to embed the barcode when a transaction is successfully completed. For example, a server computing system may be configured to calculate a hash value based on the transaction details and sign the hash value with a private key to create the digital signature. The digital signature is encoded into the barcode and the barcode (e.g., QR code) is embedded into the transaction details page.

According to example embodiments, the transaction authentication system may be configured to decrypt the digitally signed barcode either in an offline manner or an online manner.

For example, in an online implementation, a uniform resource locator (URL) may be embedded in the barcode such that a server computing system can verify the barcode. For example, the merchant may use a computing device to scan the barcode as provided on a transaction details page which is displayed on a screen of the buyer's computing device (e.g., a mobile device). The merchant's computing device may be configured to, upon scanning the barcode, obtain the URL from the barcode and access a payment service provider at the server computing system so that the barcode can be authenticated by a server transaction authentication system of the payment service provider at the server computing system. For example, the server transaction authentication system may be configured to decrypt the digital signature with a public key stored at the server transaction authentication system to obtain a decrypted hash value. For example, if the decrypted hash value does not match a hash value calculated from the transaction details, then the server transaction authentication system may be configured to determine that the barcode displayed on the buyer's computing device is not authentic and provide an appropriate response to the merchant's computing device indicating the transaction is not authentic. The merchant's computing device can provide an output including displaying an error message to indicate the transaction is not authentic. For example, if the decrypted hash value does match the hash value calculated from the encoded transaction details, then the server transaction authentication system may be configured to determine that the barcode displayed on the buyer's computing device is authentic and provide an appropriate response to the merchant's computing device indicating the transaction is authentic. The merchant's computing device can provide an output including displaying a message indicating the transaction is authentic.

In a variation of the above-described online implementation, the URL may be exposed (i.e., not embedded in the barcode) such that the URL is displayed in full on the transaction details page and the merchant can access a trusted web endpoint using the URL to perform authentication by the payment service provider as discussed above. Such an implementation can avoid a merchant being directed to possible fraudulent URLs that are embedded in a fake barcode.

For example, in an offline implementation, the merchant may use a computing device to scan the barcode as provided on a transaction details page which is displayed on a screen of the buyer's computing device (e.g., a mobile device). The merchant's computing device may be configured to decode the barcode to obtain the information associated with the transaction details. For example, the merchant's computing device may be configured to decrypt the digital signature with a public key stored at the merchant computing device (e.g., with the payment application) to obtain a decrypted hash value. For example, if the decrypted hash value does not match a hash value calculated from the encoded transaction details, then the transaction authentication system may be configured to determine that the barcode displayed on the buyer's computing device is not authentic and provide an appropriate output (e.g., displaying an error message). For example, if the decrypted hash value does match the hash value calculated from the transaction details, then the transaction authentication system may be configured to determine that the barcode displayed on the buyer's computing device is authentic and provide an appropriate output (e.g., displaying a message indicating the transaction is authentic). In the offline implementation (i.e., without accessing the internet), verification can occur completely at the merchant's computing device using the payment application stored at the merchant's computing device which stores the certificate chain used for decrypting the barcode (e.g., storing the public key). In some instances, the merchant's computing device may need to access the internet to update expired certificates, however if the necessary certificate stored at the merchant's computing device is not expired, authentication of the transaction can be performed completely offline.

In some implementations, when the barcode that is being scanned is a legitimate barcode but is not associated with either the buyer or the merchant, an error message may also be provided. For example, when the transaction details indicate the transaction is associated with Merchant A and Buyer B, and the user associated with the payment application being used to authenticate the transaction does not correspond to either Merchant A or Buyer B, such an error message may be output.

According to the embodiments described herein, the merchant is able to confirm that the transaction is authentic based on the authentication of the barcode. In addition, the merchant can confirm transaction details regarding at least: (1) the transaction time (to ensure the barcode that has been authenticated is associated with a recent transaction); (2) the transaction participants (to ensure the barcode is associated with the merchant and the buyer); and (3) the transaction amount (to ensure the correct amount has been paid for the good or service).

One or more technical benefits of the disclosure include preventing fraudulent transactions from being conducted by encrypting and embedding transaction details information in a barcode for completed transactions. Furthermore, one or more technical benefits of the disclosure include determining whether a transaction is authentic by decrypting a barcode which is provided for display on a display device of a user and determining whether the barcode is valid. One or more technical benefits of the disclosure include determining whether the transaction is authentic in an offline manner such that consumption of computing resources is reduced (e.g., reduced bandwidth usage, reduced network traffic, etc.) and such that authentication is capable of being performed quickly and accurately when a computing network is unavailable, disrupted, slow, etc. Thus, according to aspects of the disclosure, technical benefits including resource savings and transaction accuracy improvements may be achieved.

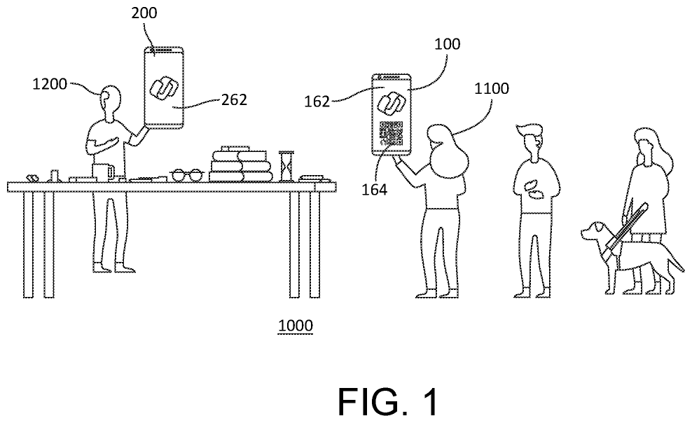

Referring now to the drawings, FIG. 1 is an example transaction environment according to one or more example embodiments of the disclosure. FIG. 1 illustrates an example of a transaction environment 1000 which includes a first computing device 100 which is associated with a first entity 1100 and a second computing device 200 which is associated with a second entity 1200. For example, the first entity 1100 may correspond to a customer or consumer who purchases goods or services from the second entity 1200 which may correspond to a merchant or seller who sells the goods or services to the first entity 1100. The first entity 1100 and second entity 1200 may correspond to an individual or a legal entity including a corporation, company, organization, and the like.

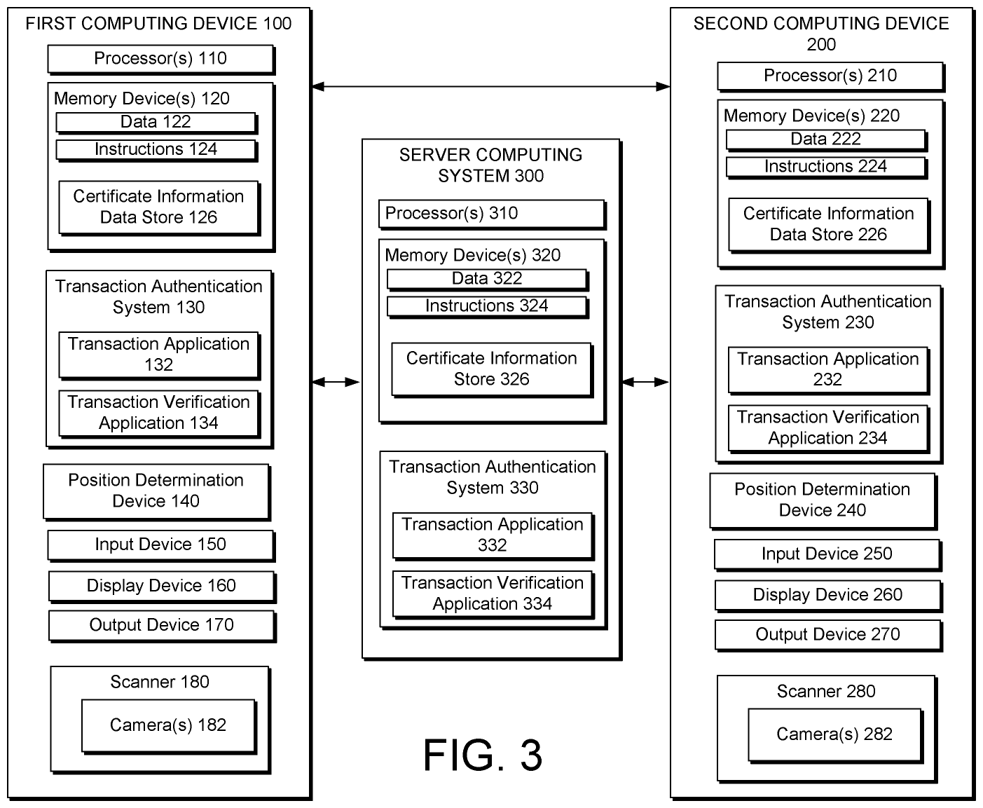

According to example embodiments described herein, when the first entity 1100 makes a purchase from the second entity 1200 via a transaction application 132 (see FIG. 3), a transaction details page of a first user interface screen 162 may be displayed on a user interface screen of the first computing device 100. The transaction details page may include various information about the transaction including one or more of the merchant name, the buyer name, a time stamp, an amount, a transaction identifier, and a status, as well as a barcode 164 (e.g., a quick response code). In some instances, the first entity 1100 may need to confirm or prove payment for a purchase from the second entity 1200 (e.g., to obtain a refund for the purchase, to obtain a refund for an overpayment, etc.). As will be described more fully below, the second entity 1200 may authenticate the validity of the transaction and of the information about the transaction, by using the second computing device 200 to scan the barcode 164 presented on the user interface screen of the first computing device 100. The barcode 164 includes encrypted information and includes digitally signed transaction details information regarding the transaction.

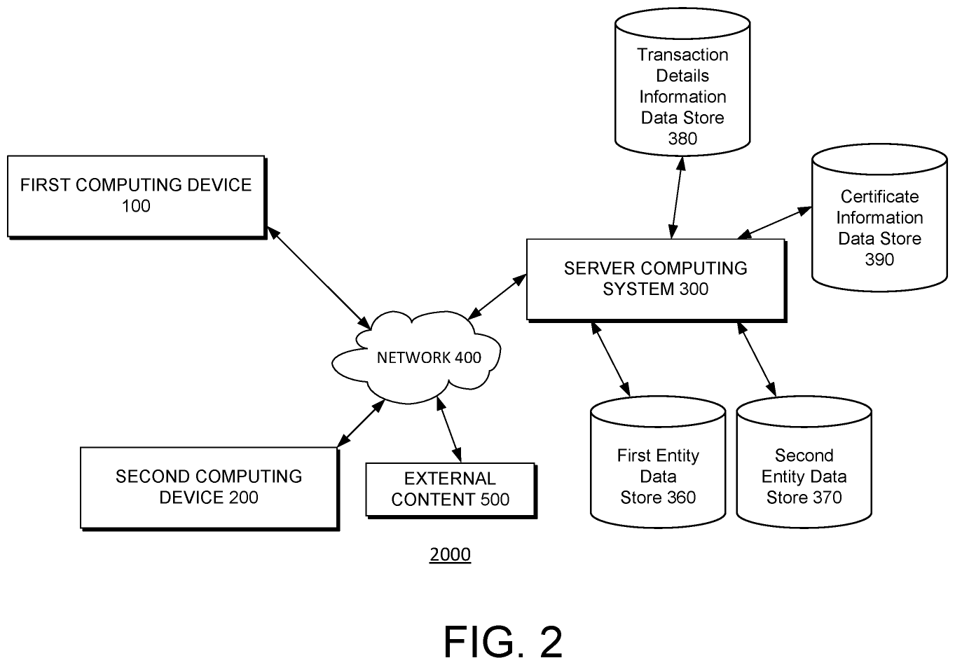

In some implementations, the second computing device 200 may be configured to transmit the scanned image of the barcode 164 to a server computing system 300 (see FIG. 2) with a request to determine whether the barcode 164 displayed on the first computing device 100 is associated with the transaction between the first entity 1100 and the second entity 1200 and is authentic. The server computing system 300 may be configured to authenticate the transaction by decrypting the encrypted transaction details information.

In some implementations, the second computing device 200 may be configured to determine itself whether the barcode displayed on the first computing device 100 is associated with the transaction between the first entity 1100 and the second entity 1200 and is authentic. The second computing device 200 may be configured to authenticate the transaction by decrypting the encrypted transaction details information. For example, the second computing device 200 may be configured to authenticate the transaction in an offline manner (without being connected to the internet).

For example, a result of the authentication process may be displayed on a user interface screen 262 of a display device 260 of the second computing device 200 indicating whether the transaction is authentic or not authentic.

Referring now to FIG. 2, an example system according to one or more example embodiments of the disclosure is illustrated. FIG. 2 illustrates an example of a system 2000 which includes the first computing device 100, the second computing device 200, a server computing system 300, and external content 500, which may be in communication with one another over a network 400. For example, the first computing device 100 and the second computing device 200 can include any of a personal computer, a smartphone, a tablet computer, a global positioning service device, a smartwatch, and the like. The network 400 may include any type of communications network such a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the first computing device 100, second computing device 200, and/or server computing system 300 may form part of a transaction authentication system which authenticates or validates transactions between the first entity 1100 and second entity 1200.

In some example embodiments, the server computing system 300 may obtain data from one or more of a first entity data store 360, a second entity data store 370, a transaction details information data store 380, and a certificate information data store 390, to implement various operations and aspects of the transaction authentication system as disclosed herein. The first entity data store 360, second entity data store 370, transaction details information data store 380, and certificate information data store 390 may be integrally provided with the server computing system 300 (e.g., as part of the one or more memory devices 320 of the server computing system 300) or may be separately (e.g., remotely) provided. Further, first entity data store 360, second entity data store 370, transaction details information data store 380, and certificate information data store 390 can be combined as a single data store (database), or may be a plurality of respective data stores. Data stored in one data store (e.g., the first entity data store 360) may overlap with some data stored in another data store (e.g., the certificate information data store 390). In some implementations, one data store (e.g., the first entity data store 360) may reference data that is stored in another data store (e.g., the certificate information data store 390).

In some example embodiments, the first entity data store 360 can represent a single database. In some embodiments, the first entity data store 360 represents a plurality of different databases accessible to the server computing system 300. In some examples, the first entity data store 360 can include location information about the first computing device 100 with which the first entity 1100 is associated. In some examples, the first entity data store 360 can include information regarding one or more user profiles, including a variety of user data including user preference data, user demographic data, user calendar data, user social network data, user historical travel data, and the like. For example, the first entity data store 360 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including sales or purchases, electronic tickets, coupons, or deals; scheduling data; location data; SMS data; or other suitable data associated with a user account. According to one or more examples of the disclosure, where the first entity 1100 corresponds to a buyer or consumer, a history of purchases may be stored in the first entity data store 360, where such data can include transaction details information including one or more of a transaction time, first entity information, second entity information, a unique identifier associated with the second entity 1200, status information, or an amount of the transaction. Such information may be used to generate a user interface screen for a transaction details page that is displayed by the display device 160.

The first entity data store 360 is provided to illustrate potential data that could be analyzed, in some embodiments, by the server computing system 300 to authenticate a transaction between the first entity 1100 and the second entity 1200. However, such data may not be collected, used, or analyzed unless the first entity 1100 has consented after being informed of what data is collected and how such data is used. Further, in some embodiments, the first entity 1100 can be provided with a tool (e.g., in a transaction application 132 or via a user account) to revoke or modify the scope of permissions. In addition, certain information or data can be treated in one or more ways before it is stored or used, so that personally identifiable information is removed or stored in an encrypted fashion. Thus, particular user information stored in the first entity data store 360 may or may not be accessible to the server computing system 300 based on permissions given by the user, or such data may not be stored in the first entity data store 360 at all.

In some example embodiments, the second entity data store 370 can represent a single database. In some embodiments, the second entity data store 370 represents a plurality of different databases accessible to the server computing system 300. In some examples, the second entity data store 370 can include location information about the second computing device 200 with which the second entity 1200 is associated. In some examples, the second entity data store 370 can include information regarding one or more user profiles, including a variety of user data including user preference data, user demographic data, user calendar data, user social network data, user historical travel data, and the like. For example, the second entity data store 370 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including sales or purchases, electronic tickets, coupons, or deals; scheduling data; location data; SMS data; or other suitable data associated with a user account. According to one or more examples of the disclosure, where the second entity 1200 corresponds to a merchant or seller, a history of sales may be stored in the second entity data store 370, where such data can include transaction details information including one or more of a transaction time, first entity information, second entity information, a unique identifier associated with the second entity 1200, status information, or an amount of the transaction. Such information may be used to generate a user interface screen for a transaction details page that is displayed by the display device 260.

The second entity data store 370 is provided to illustrate potential data that could be analyzed, in some embodiments, by the server computing system 300 to authenticate a transaction between the first entity 1100 and the second entity 1200. However, such data may not be collected, used, or analyzed unless the second entity 1200 has consented after being informed of what data is collected and how such data is used. Further, in some embodiments, the second entity 1200 can be provided with a tool (e.g., in a transaction application 232 or via a user account) to revoke or modify the scope of permissions. In addition, certain information or data can be treated in one or more ways before it is stored or used, so that personally identifiable information is removed or stored in an encrypted fashion. Thus, particular user information stored in the second entity data store 370 may or may not be accessible to the server computing system 300 based on permissions given by the user, or such data may not be stored in the second entity data store 370 at all.

In some example embodiments, the transaction details information data store 380 can represent a single database. In some embodiments, the transaction details information data store 380 represents a plurality of different databases accessible to the server computing system 300. In some examples, the transaction details information data store 380 can include data associated with a transaction between the first entity 1100 and the second entity 1200. For example, such data can include transaction details information including one or more of a transaction time, first entity information, second entity information, a unique identifier associated with the second entity 1200, status information, or an amount of the transaction. In addition, information about the first computing device 100 and/or the second computing device 200 which may be associated with the transaction or authentication of the transaction (e.g., identification information, location information, a number of times the barcode has been scanned by the second computing device 200, etc.) may be stored in the transaction details information data store 380. The server computing system 300 may configured to access data from the transaction details information data store 380 when generating an encoded or encrypted barcode image which is transmitted to the first computing device 100.

In some example embodiments, the certificate information data store 390 can represent a single database. In some embodiments, the certificate information data store 390 represents a plurality of different databases accessible to the server computing system 300. In some examples, the certificate information data store 390 can include information relating to the generation of a barcode (e.g., a QR code) which includes digitally signed transaction details information. For example, the server computing system 300 may be configured to store secure service provider certificates (i.e., certificates issued by a certificate authority). For example, the server computing system 300 may be configured to insert a digital signature which includes the transaction details information in the barcode using a private key stored at the certificate information data store 390. For example, the certificate information data store 390 may store the private key and a public key used to decrypt the digital signature. For example, the public key used to decrypt the digital signature may be obtained from the certificate information data store 390 and subsequently stored at the second computing device 200 (e.g., in certificate information data store 226). The certificate information data store 390 may store information about the certificate authority including identification information (e.g., a name of the organization issuing the certificate, address, etc.).

External content 500 can be any form of external content including news articles, webpages, video files, audio files, written descriptions, ratings, game content, social media content, photographs, commercial offers, transportation method, weather conditions, or other suitable external content. The first computing device 100, second computing device 200, and server computing system 300 can access external content 500 over network 400. External content 500 can be searched by server computing system 300 according to known searching methods and search results can be ranked according to relevance, popularity, or other suitable attributes, including location-specific filtering or promotion. For example, first computing device 100, second computing device 200, and server computing system 300 can access external content 500 for content relating to generating user interface screens for presentation on display device 160 or display device 260.

Referring now to FIG. 3, example block diagrams of first and second computing devices and the server computing system, according to one or more example embodiments of the disclosure will now be described.

The first computing device 100 may include one or more processors 110, one or more memory devices 120, a transaction authentication system 130, a position determination device 140, an input device 150, a display device 160, an output device 170, and a scanner 180. The second computing device 200 may include one or more processors 210, one or more memory devices 220, a transaction authentication system 230, a position determination device 240, an input device 250, a display device 260, an output device 270, and a scanner 280. The server computing system 300 may include one or more processors 310, one or more memory devices 320, and a transaction authentication system 330.

For example, the one or more processors 110, 210, 310 can be any suitable processing device that can be included in a first computing device 100, second computing device 200, or server computing system 300. For example, the one or more processors 110, 210, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 210, 310 can be a single processor or a plurality of processors that are operatively connected, for example in parallel.

The one or more memory devices 120, 220, 320 can include one or more non-transitory computer-readable storage mediums, for example a Read Only Memory (ROM), Programmable Read Only Memory (PROM), Erasable Programmable Read Only Memory (EPROM), and flash memory, a USB drive, a volatile memory device for example a Random Access Memory (RAM), a hard disk, floppy disks, a blue-ray disk, or optical media including CD ROM discs and DVDs, and combinations thereof. However, examples of the one or more memory devices 120, 220, 320 are not limited to the above description, and the one or more memory devices 120, 220, 320 may be realized by other various devices and structures as would be understood by those skilled in the art.

For example, one or more memory devices 120 can store instructions 124, that when executed, cause the one or more processors 110 to execute a computing application (e.g., transaction application 132 and/or transaction verification application 134). For example, in response to the first entity 1100 purchasing a good or service via the transaction application 132, the instructions 124 may cause transaction verification application 134 to be executed and a request associated with the transaction between the first entity 1100 associated with the first computing device 100 and the second entity 1200 may be transmitted to the server computing system 300. For example, the request may be a request for the server computing system 300 to generate a barcode which includes encrypted information including an embedded and digitally signed string (e.g., a base 64 QR string) that contains the transaction details information. The instructions 124 may further include instructions for receiving, from the server computing system 300, the barcode including the encrypted transaction details information embedded in the barcode. For example, the transaction details information may be associated with the completion of the transaction between the first entity 1100 and the second entity 1200. The instructions 124 may further include instructions for providing, for display by the display device 160, the barcode and at least a portion of the transaction details information including one or more of a transaction time, first entity information, second entity information, a unique identifier associated with the second entity, status information, or an amount of the transaction, as described according to examples of the disclosure.

For example, one or more memory devices 220 can store instructions 224, that when executed, cause the one or more processors 210 to execute a computing application (e.g., transaction application 232 and/or transaction verification application 234). For example, when the second entity 1200 wishes to authenticate or verify a transaction with the first entity 1100, transaction verification application 234 may be executed and the instructions 224 may include instructions associated with the transaction verification application 234 that cause the one or more cameras 282 of the scanner 280 to capture an image of a barcode provided on a display of the display device 160 of the first computing device 100, wherein the barcode is potentially associated with the transaction between the first entity 1100 associated with the first computing device 100 and the second entity 1200 associated with the second computing device 200. The instructions 224 may further include instructions for determining whether the barcode is authentic based on a decryption of encrypted transaction details information embedded in the barcode and a determination of whether a first hash value calculated based on the transaction details information is equal to a second hash value calculated based on a digital signature used to digitally sign the transaction details information. The instructions 224 may further include providing, for display on the display device 260, a first notification indicating the barcode is not authentic (e.g., when the first hash value calculated based on the transaction details information is not equal to the second hash value calculated based on the digital signature used to digitally sign the transaction details information) and providing, for display on the display device 260, a second notification indicating the barcode is authentic when the first hash value calculated based on the transaction details information is equal to the second hash value calculated based on the digital signature used to digitally sign the transaction details information.

For example, one or more memory devices 320 can store instructions 324, that when executed, cause the one or more processors 310 to execute a computing application (e.g., transaction application 332 and/or transaction verification application 334). For example, when the first entity 1100 requests to receive an encrypted barcode from the server computing system 300 and/or when the second entity 1200 wishes to authenticate or verify a transaction with the first entity 1100, the transaction verification application 334 may be executed and the instructions 324 may be executed. For example, the instructions 324 may include instructions to receive a request associated with the transaction between the first entity 1100 and the second entity 1200, to generate transaction details information associated with completion of the transaction via a first computing device associated with the first entity, to encrypt the transaction details information by digitally signing the transaction details information, and to transmit the encrypted transaction details information to the first computing device. For example, the instructions 324 may include instructions to receive an image of a barcode potentially associated with the transaction between the first entity 1100 and the second entity 1200. The instructions 324 may further include instructions for determining whether the barcode is authentic based on a decryption of encrypted transaction details information embedded in the barcode and for determining whether a first hash value calculated based on the transaction details information is equal to a second hash value calculated based on a digital signature used to digitally sign the transaction details information. The instructions 224 may further include providing, to the second computing device 200, a first indication that the barcode is not authentic when the server computing system 300 determines the first hash value is not equal to the second hash value and providing, to the second computing device 200, a second indication that the barcode is authentic when the server computing system 300 determines the first hash value is equal to the second hash value.

One or more memory devices 120 can also include data 122 and instructions 124 that can be retrieved, manipulated, created, or stored by the one or more processors 110. In some example embodiments, such data can be accessed and used as input to execute the computing application (e.g., the transaction application 132 and/or transaction verification application 134), as described according to examples of the disclosure. One or more memory devices 220 can also include data 222 and instructions 224 that can be retrieved, manipulated, created, or stored by the one or more processors 210. In some example embodiments, such data can be accessed and used as input to execute the computing application (e.g., the transaction application 232 and/or transaction verification application 234), as described according to examples of the disclosure. One or more memory devices 320 can also include data 322 and instructions 324 that can be retrieved, manipulated, created, or stored by the one or more processors 310. In some example embodiments, such data can be accessed and used to execute the computing application (e.g., the transaction application 332 and/or transaction verification application 334), as described according to examples of the disclosure.

In some example embodiments, the first computing device 100 includes the transaction authentication system 130 which includes the transaction application 132 and transaction verification application 134. The transaction application 132 may be an application which can be used as a mobile payment system (e.g., a contactless payment method using near-field communication). However, the transaction application can be any application by which an entity (i.e., a user) can provide payment for goods or services using the first computing device 100. As described according to examples disclosed herein, transaction verification application 134 may be an application that can be used to prove or verify payment for the goods or services purchased, for example, using the transaction application 132.

The transaction authentication system 230 may include transaction application 232 and transaction verification application 234 and may correspond to the transaction authentication system 130 including the transaction application 132 and transaction verification application 134. Therefore, a detailed description thereof will be omitted for the sake of brevity. In some examples, one or more aspects of the transaction authentication system 130 may be implemented by the transaction authentication system 330 of the server computing system 300. For example, in some implementations the transaction verification application 334 may perform authentication operations with respect to a scanned image of a barcode received from the second computing device 200. For example, in some implementations the transaction verification application 334 may perform encryption operations with respect to a transaction between the first entity 1100 and the second entity 1200, according to a request from the first computing device 100.

In some examples, the transaction applications 132, 232, 332 and transaction verification applications 134, 234, 334 can be dedicated applications specifically designed to provide services relating to transaction and verification of transactions. In other examples, the transaction applications 132, 232, 332 and transaction verification applications 134, 234, 334 can be general applications (e.g., a web browser) that can provide access to a variety of different services including navigation services, financial services, infotainment services, etc., via the network 400.

For example, the position determination devices 140, 240 can determine a current geographic location of the associated computing device (e.g., first computing device 100 and second computing device 200, respectively) and communicate such geographic location to server computing system 300 over network 400. The position determination devices 140, 240 can be any device or circuitry for analyzing the position of the associated computing device. For example, the position determination devices 140, 240 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining a position of the associated computing device.

For example, input devices 150, 250 may be configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input including a voice command or a voice query), an output sound device (e.g., a speaker), a track ball, a remote controller, a portable (e.g., a cellular or smart) phone, a tablet PC, a pedal or footswitch, a virtual-reality device, and so on. The input devices 150, 250 may further include a haptic device to provide haptic feedback to a user. The input devices 150, 250 may also be embodied by a touch-sensitive display having a touchscreen capability, for example.

The display devices 160, 260 may be configured to display information viewable by the user (e.g., user interface screens which show transaction details information). For example, the display devices 160, 260 may be a non-touch sensitive display or a touch-sensitive display. The display devices 160, 260 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display devices 160, 260 can be used by the transaction authentication systems 130, 230 to display information to a user relating to transactions between the first entity 1100 and the second entity 1200. For example, the display device 160 can display a user interface screen which includes a barcode and transaction details information concerning a transaction between the first entity 1100 and the second entity 1200. For example, the display device 260 can display user interface screens which confirm whether a barcode is authentic or not authentic.

For example, output devices 170, 270 may be configured to provide an output to the user and may include, for example, one or more of an audio device (e.g., one or more speakers), a haptic device to provide haptic feedback to a user (e.g., a vibration device), a light source (e.g., one or more light sources including LEDs which provide visual feedback to a user), a thermal feedback system, and the like. According to various examples of the disclosure, the output device 170, 270 may provide an output relating to the authentication of a barcode which is used to confirm a transaction between the first entity 1100 and the second entity 1200. For example, if the transaction is determined to be not authentic by second computing device 200, output device 270 may be configured to output a sound which serves as a warning or alarm to alert a user of the second computing device 200.

For example, scanners 180, 280 may be configured to capture (e.g., scan) an image of a document (e.g., of a physical document or of an image including a barcode presented on a display) using one or more cameras 182, 282. For example, second computing device 200 may include scanner 280 which scans an image of a barcode presented on a display or user interface screen of display device 160, according to examples described herein.

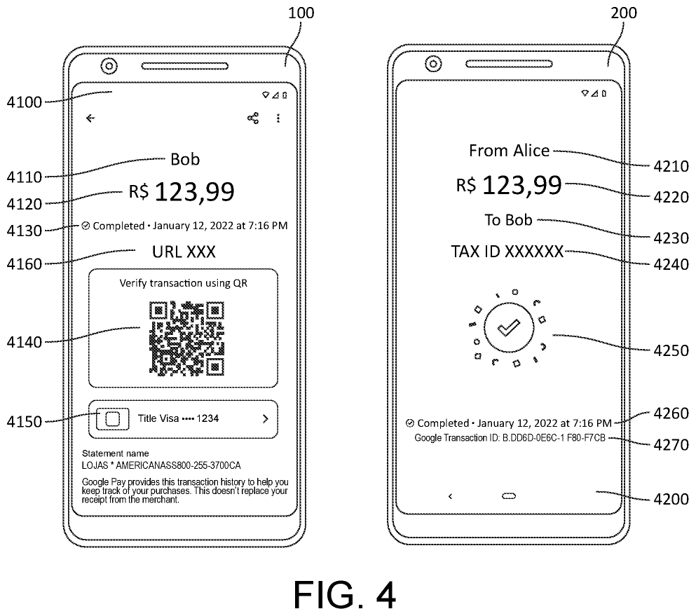

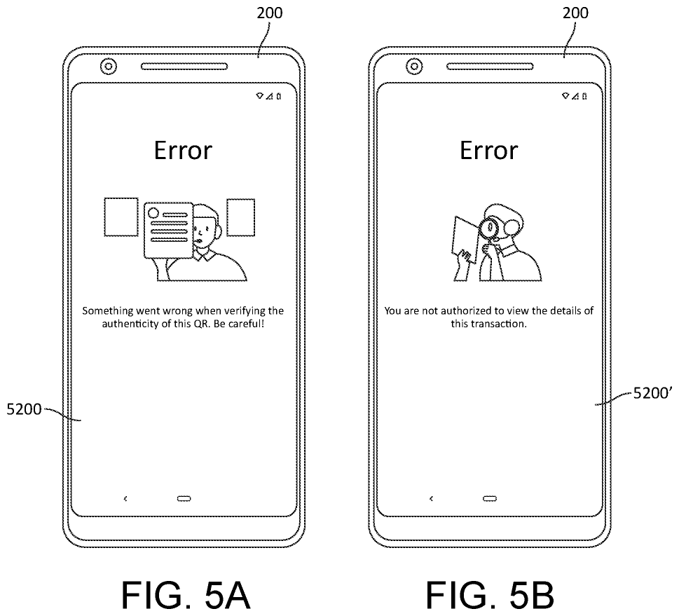

FIG. 4 and FIGS. 5A-5B are example user interface screens of computing devices which may be provided when authenticating a transaction between a first entity and a second entity, according to one or more examples of the disclosure.

Referring to FIG. 4, an example illustration of user interface screens associated with the first computing device 100 and second computing device 200 are shown, according to one or more examples of the disclosure.

As a non-limiting example, FIG. 4 illustrates the first computing device 100 having a display which presents on user interface screen 4100 various user interface elements that provide transaction details information regarding a completed transaction between the first entity 1100 and second entity 1200. For example, in FIG. 4 user interface screen 4100 includes a first user interface element 4110 indicating the identity of the second entity 1200 (“Bob”), a second user interface element 4120 which indicates an amount of the transaction (“R$123,99”), a third user interface element 4130 which indicates a status of the transaction and a date and time of the transaction (“Completed—Jan. 12, 2022 at 7:16 PM”), a fourth user interface element 4140 which corresponds to a barcode (e.g., a QR code) that can be used to verify the transaction, and fifth user interface element 4150 that indicates the form of payment (e.g., a particular credit card). The user interface screen 4100 can include additional or fewer user interface elements than those described in the example, however aspects of the disclosure utilize the barcode to verify the transaction between the first entity 1100 and the second entity 1200 as described herein. For example, in FIG. 4 user interface screen 4100 may include an exposed sixth user interface element 4160 indicating a URL address which, when accessed by the second computing device 200, serves as a web endpoint for a payment service provider at the server computing system 300 so that the barcode can be authenticated by the transaction authentication system 330. In another implementation, the URL address may be embedded in the barcode. For example, second computing device 200 may be configured to, upon scanning the barcode, obtain the URL from the barcode and access a payment service provider at the server computing system 300 so that the barcode can be authenticated by the transaction authentication system 330.

As a non-limiting example, FIG. 4 illustrates the second computing device 200 having a display which presents on user interface screen 4200 various user interface elements that provide transaction details information regarding a completed transaction between the first entity 1100 and second entity 1200. For example, in FIG. 4 user interface screen 4100 may be provided after a successful authentication of the barcode presented on the user interface screen 4100 of the first computing device 100 and which is scanned by the second computing device 200. For example, in FIG. 4 user interface screen 4100 includes a first user interface element 4210 indicating the identity of the first entity (“Alice”), a second user interface element 4220 which indicates an amount of the transaction (“R$123,99”), a third user interface element 4230 which indicates an identity of the second entity (“Bob”), a fourth user interface element 4240 which indicates a unique second entity identifier (e.g., a tax identification number associated with the second entity, a user identifier associated with the second entity, or any identifier which may be unique or is specific to the second entity 1200 and known to the second entity 1200), a fifth user interface element 4250 which indicates whether authentication of the transaction is successful (e.g., when the authentication is successful a checkmark, a celebratory symbol, etc. may be presented), a sixth user interface element 4260 which indicates a status of the transaction and a date and time of the transaction (“Completed—Jan. 12, 2022 at 7:16 PM”), a seventh user interface element 4270 which indicates a transaction identifier of the transaction application 232 associated with the transaction. The user interface screen 4200 can include additional or fewer user interface elements than those described in the example, however aspects of the disclosure including providing some kind of indication or notification to the second entity 1200 via the second computing device 200 when authenticating the barcode that is presented on the display of the first computing device 100 to verify the transaction between the first entity 1100 and the second entity 1200 as described herein.

As illustrated in FIG. 4, after a successful authentication of the barcode (either by the server computing system 300 or the second computing device 200), at least some of the information presented on the user interface screen 4200 is extracted from the barcode and presented on the display of the first computing device 100. For example, after successfully decrypting the information included in the barcode (either by the server computing system 300 or the second computing device 200), transaction details information can be extracted from the barcode and be provided for presentation on the display of the second computing device 200. For example, the transaction details information which is obtained from the barcode and presented on the display of the second computing device 200 may include one or more of the identity of the first entity (first user interface element 4210), an amount of the transaction (second user interface element 4220), the identity of the second entity (third user interface element 4230), the unique second entity identifier (fourth user interface element 4240), the status of the transaction and the date and time of the transaction (sixth user interface element 4260), and the transaction identifier of the transaction application 232 (seventh user interface element 4270).

For example, either the server computing system 300 or the second computing device 200 can determine whether the barcode is authentic based on a decryption of encrypted transaction details information embedded in the barcode and by determining whether a first hash value calculated based on the transaction details information is equal to a second hash value calculated based on a digital signature used to digitally sign the transaction details information. When the first hash value is not equal to the second hash value (as determined by either the server computing system 300 or the second computing device 200), the second computing device 200 may be configured to provide an output indicating the authenticity of the barcode could not be verified (see, e.g., FIG. 5A which illustrates user interface screen 5200 displaying a message that an error has occurred when authenticating the QR code presented on the first computing device 100). In some instances, the barcode which is scanned may be an authentic barcode associated with a valid transaction, however the transaction may be associated with an entity other than the first entity 1100 or the second entity 1200. For example, where the barcode displayed on the display of the first computing device 100 pertains to a transaction between the first entity 1100 and a third entity, the second entity 1200 (which is associated with the second computing device 200) may not be authorized to view the transaction details information associated with that transaction. For example, FIG. 5B illustrates user interface screen 5200′ displaying a message that an error has occurred because the user associated with the second computing device 200 (or associated with the transaction authentication system 230 including transaction application 232 and transaction verification application 234) is not authorized to view the details of the transaction. For example, transaction verification applications 134, 234, 334 may be configured to compare the user or entity information associated with a computing device requesting to verify the authenticity of a transaction with the entities involved in the transaction. When the user or entity information associated with the computing device requesting to verify the authenticity of the transaction is not one of the entities involved in the transaction or is not otherwise authorized to view transactions involving other entities (e.g., an entity without administrative rights), an error message may be provided and subsequently displayed, for example as illustrated in FIG. 5B.

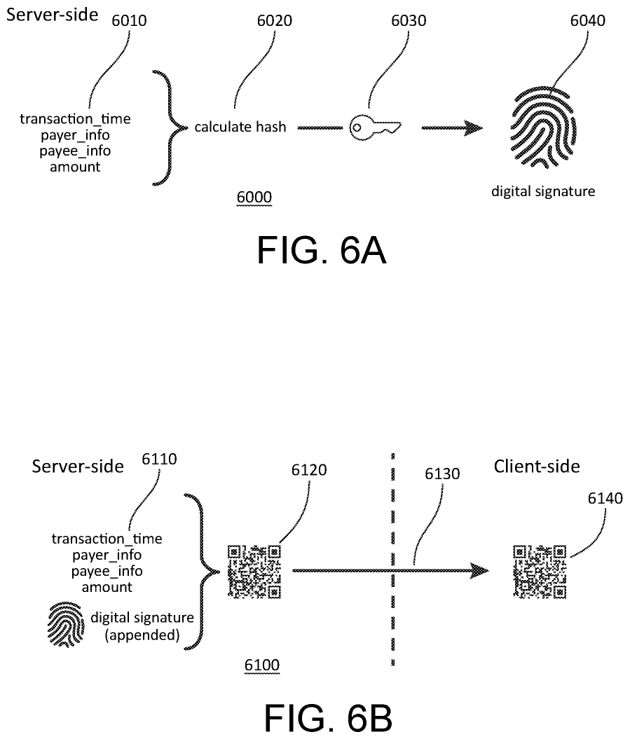

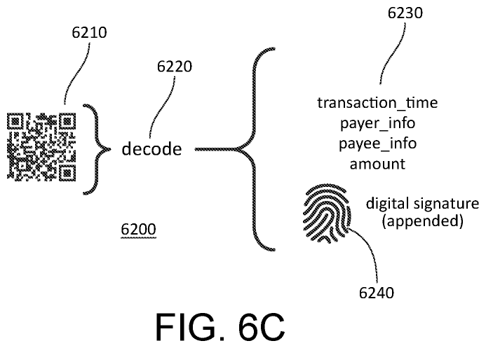

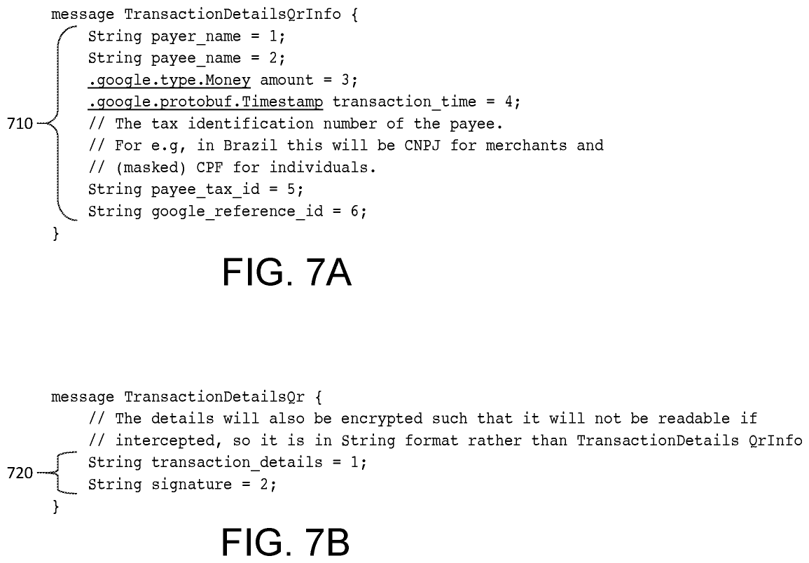

FIGS. 6A-6C are example processes for verifying or authenticating a transaction between a first entity and a second entity, according to one or more examples of the disclosure. FIGS. 7A-7B are examples of programming syntax for defining messages regarding generating strings for transaction details information and for a digital signature, according to one or more examples of the disclosure.

For example, FIG. 6A illustrates a process 6000 by which the server computing system 300 generates a digital signature and calculates a hash value with respect to the transaction details information associated with a transaction between the first entity 1100 and the second entity 1200. For example, when a transaction is completed between the first computing device 100 and the second computing device 200, the first computing device 100 may be configured to transmit a request to the server computing system 300. The request may be a request for the server computing system 300 to generate a barcode which includes encrypted information, for example, an embedded and digitally signed string (e.g., a base 64 QR string) that contains transaction details information associated with the transaction. The request may further include the transaction details information or an identifier or link that corresponds to the transaction details information which the server computing system 300 can utilize to obtain the transaction details information (e.g., from the transaction details information data store 380). In some implementations, the server computing system 300 may be configured to automatically generate the barcode and transmit the barcode to the first computing device 100 in response to receiving an indication from the transaction application 332 that a transaction has been conducted or completed which involves first computing device 100. At operation 6010, the server computing system can obtain or receive the transaction details information from the first computing device 100 or from transaction details information data store 380. For example, the transaction details information can include time information concerning the transaction so that the second entity 1200 can verify a time or freshness of the transaction when the transaction details information is provided to the second computing device 200. For example, the transaction details information can identify the participants of the transaction including the first entity 1100 and second entity 1200 so that the second entity 1200 can verify that the first entity 1100 and second entity 1200 conducted a transaction, when the transaction details information is provided to the second computing device 200. For example, the transaction details information can identify the amount of the transaction so that the second entity 1200 can verify the correct amount of the transaction, when the transaction details information is provided to the second computing device 200. Other information may also be included as part of the transaction details information, for example, a unique identifier associated with the second entity, a reference identifier associated with the transaction and the entity which is associated with the transaction application that provides transaction related services, etc.

At operation 6020 the server computing system 300 (e.g., transaction verification application 334) can calculate a hash value associated with the transaction details information. For example, a SHA-256 hash may be used to calculate the hash value. At operation 6030 the server computing system 300 (e.g., transaction verification application 334) can encrypt the transaction details information (e.g., using a private key). At operation 6040 the server computing system 300 (e.g., transaction verification application 334) generates a digital signature associated with the transaction details information.

For example, FIG. 6B illustrates a process 6100 by which the server computing system 300 transmits a barcode including encoded and encrypted information to the first computing device 100 where the barcode, for example, includes an embedded digital signature and encrypted transaction details information. In some implementations, the barcode may include an embedded URL that, when scanned by the second computing device 200, causes the second computing device 200 to access a web endpoint of the server computing system 300 for the purpose of verifying the transaction via the transaction verification application 334.

For example, at operation 6110 the server computing system 300 (e.g., transaction verification application 334) obtains the transaction details information and the digital signature. At operation 6120 the server computing system 300 (e.g., transaction verification application 334) generates the barcode (e.g., the QR code) by encoding and embedding the transaction details information and the digital signature into the barcode. Referring to FIG. 7A, section 710 includes example transaction details information regarding a transaction which can include various strings containing entity information (e.g., regarding a payor and payee), time information, entity identifier information (e.g., of the payee, for example a tax identification number), and a reference identifier concerning the transaction. Referring to FIG. 7B, information which is to be encoded and embedded in the barcode is included in two strings as indicated by section 720. For example, the first string includes the transaction details information and the second string includes the digital signature. For example, server computing system 300 may be configured to convert the first and second strings into a barcode image (e.g., a QR code image).

At operation 6130 the server computing system 300 transmits the generated barcode image to the first computing device 100 (client-side). At operation 6140 the first computing device 100 is configured to embed the barcode in a user interface screen, for example as shown in FIG. 4 with respect to fourth user interface element 4140. For example, the user interface screen 4100 of the first computing device 100 may be referred to as a transaction details page that may be presented based on a user input with respect to the transaction application 132 and/or transaction verification application 134.

For example, FIG. 6C illustrates a process 6200 by which either the server computing system 300 or the second computing device 200 may be configured to decode and verify the barcode. Therefore, operations described with respect to FIG. 6C are applicable to either the server computing system 300 or the second computing device 200 which may be executed by either transaction verification application 234 or transaction verification application 334, for example. For example, at operation 6210 an image of the barcode is received, for example via a scanning operation performed by scanner 280 which scans an image of a barcode presented on the display of first computing device 100. In some implementations, the image of the barcode may be received by the server computing system 300 in response to the scanning operation performed by scanner 280. For example, at operation 6220 the barcode may be decoded by separating the content of the barcode back into the transaction details information 6230 and the appended digital signature 6240.

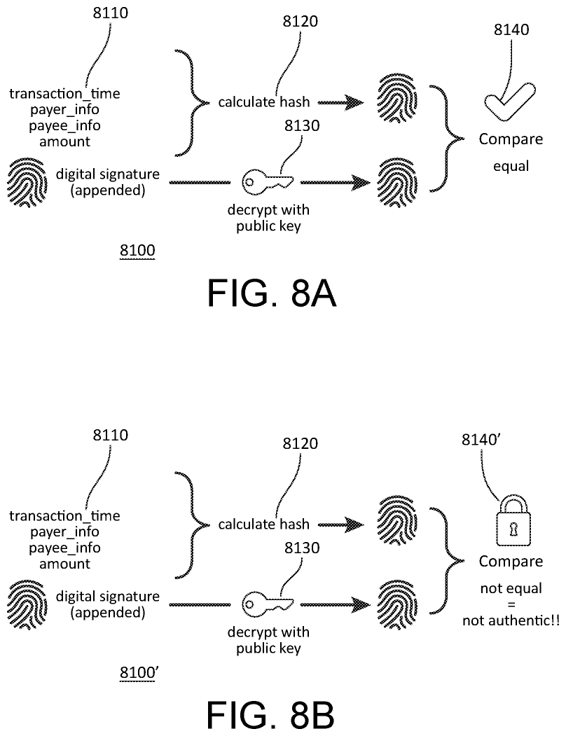

FIGS. 8A-8B are example processes for verifying or authenticating a transaction between a first entity and a second entity, according to one or more examples of the disclosure.

For example, FIGS. 8A-8B illustrate a process 8100 and a process 8100′, respectively, by which either the server computing system 300 or the second computing device 200 may be configured to decode and verify the barcode. Therefore, operations described with respect to FIGS. 8A-8B are applicable to either the server computing system 300 or the second computing device 200 which may be executed by either transaction verification application 234 or transaction verification application 334, for example. For example, at operation 8110 content of the barcode has been separated back into the transaction details information and the appended digital signature. At operation 8120 the hash value of the transaction details information is calculated to obtain a calculated hash value (e.g., using the same method implemented by the server computing system, for example, SHA-256). At operation 8130 the digital signature may be decrypted using a corresponding public key to obtain an expected hash value. For example, the public key may be stored at the server computing system (e.g., in certificate information data store 390) or may be stored locally at the second computing device 200.

Operation 8140 illustrates an example where the expected hash value is equal to the calculated hash value, and the barcode is an authentic barcode. In an implementation by which the second computing device 200 (transaction verification application 234) requests the server computing system 300 to authenticate the barcode in an online authentication mode (first mode), the server computing system 300 (transaction verification application 334) is configured to provide a notification to the second computing device 200 indicating the barcode is authentic when the hash value calculated based on the transaction details information is equal to the expected hash value calculated based on the digital signature used to digitally sign the transaction details information. In an implementation by which the second computing device 200 itself authenticates the barcode (second mode), for example in an offline authentication mode, the second computing device 200 (transaction verification application 234) is configured to provide, for display on the display device 260, a notification indicating the barcode is authentic when determining the barcode is authentic.

Operation 8140′ illustrates an example where the expected hash value is not equal to the calculated hash value, and the barcode is not an authentic barcode. In an implementation by which the second computing device 200 (transaction verification application 234) requests the server computing system 300 to authenticate the barcode in an online authentication mode (first mode), the server computing system 300 (transaction verification application 334) is configured to provide another notification to the second computing device 200 indicating the barcode is not authentic when the hash value calculated based on the transaction details information is not equal to the expected hash value calculated based on the digital signature used to digitally sign the transaction details information. In an implementation by which the second computing device 200 itself authenticates the barcode (second mode), for example in an offline authentication mode, the second computing device 200 (transaction verification application 234) is configured to provide, for display on the display device 260, a notification indicating the barcode is not authentic when determining the barcode is not authentic.

To the extent terms “module”, and “unit,” and the like are used herein, such terms may refer to, but are not limited to, a software or hardware component or device, for example a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, for example, software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media, for example, hard disks, floppy disks, and magnetic tape; optical media including CD ROM disks, Blue-Ray disks, and DVDs; magneto-optical media including optical discs; and other hardware devices that are specially configured to store and perform program instructions, including semiconductor memory, read-only memory (ROM), random access memory (RAM), flash memory, USB memory, and the like. Examples of program instructions include both machine code, for example as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A method, comprising:
receiving, by one or more processors, a request associated with a transaction between a first entity and a second entity;
generating, by the one or more processors, transaction details information associated with completion of the transaction via a first computing device associated with the first entity;
encrypting, by the one or more processors, the transaction details information by digitally signing the transaction details information; and
transmitting, by the one or more processors, the transaction details information encrypted by the one or more processors, to the first computing device.

2. The method of claim 1, wherein the transaction details information includes at least one of a transaction time, first entity information, second entity information, a unique identifier associated with the second entity, status information, or an amount of the transaction.

3. The method of claim 1, further comprising:
embedding, by the one or more processors, the transaction details information encrypted by the one or more processors, in a barcode; and
transmitting, by the one or more processors, the barcode including the transaction details information encrypted by the one or more processors and embedded in the barcode, to the first computing device.

4. The method of claim 3, wherein the barcode corresponds to a quick response code.

5. The method of claim 1, further comprising:
receiving, by the one or more processors, a request to determine whether a barcode displayed on the first computing device is associated with the transaction and is authentic; and
authenticating the transaction by decrypting the transaction details information encrypted by the one or more processors, wherein the transaction details information is embedded in the barcode.

6. The method of claim 5, further comprising:
providing a first notification indicating the barcode is not authentic when a first hash value calculated based on the transaction details information is not equal to a second hash value calculated based on a digital signature used to digitally sign the transaction details information; and
providing a second notification indicating the barcode is authentic when the first hash value calculated based on the transaction details information is equal to the second hash value calculated based on the digital signature used to digitally sign the transaction details information.

7. A first computing device, comprising:
a display device;
at least one memory to store instructions; and
at least one processor configured to execute the instructions to perform operations, the operations comprising:
capturing an image of a barcode provided on a display of a second computing device, wherein the barcode is potentially associated with a transaction between a first entity associated with the first computing device and a second entity associated with the second computing device,
determining whether the barcode is authentic based on a decryption of encrypted transaction details information embedded in the barcode and a determination of whether a first hash value calculated based on the transaction details information is equal to a second hash value calculated based on a digital signature used to digitally sign the transaction details information,
providing, for display on the display device, a first notification indicating the barcode is not authentic when determining the barcode is not authentic, and
providing, for display on the display device, a second notification indicating the barcode is authentic when determining the barcode is authentic.

8. The first computing device of claim 7, wherein the transaction details information includes at least one of a transaction time, first entity information, second entity information, a unique identifier associated with the first entity, status information, or an amount of the transaction.

9. The first computing device of claim 7, wherein the operations further comprise decrypting the encrypted transaction details information embedded in the barcode without an internet connection.

10. The first computing device of claim 9, wherein the barcode corresponds to a quick response code.

11. The first computing device of claim 9, wherein decrypting the encrypted transaction details information embedded in the barcode without the internet connection includes decrypting the digital signature using a public key stored at the first computing device.

12. The first computing device of claim 7, wherein the operations further comprise:
transmitting, to a server computing system, the image of the barcode, and
determining whether the barcode is authentic includes:
receiving, from the server computing system, a first indication that the barcode is not authentic when the server computing system determines the first hash value is not equal to the second hash value, and
receiving, from the server computing system, a second indication that the barcode is authentic when the server computing system determines the first hash value is equal to the second hash value.

13. The first computing device of claim 12, wherein the barcode corresponds to a quick response code.

14. The first computing device of claim 12, wherein
a uniform resource locator is embedded in the barcode, and
transmitting, to the server computing system, the image of the barcode is in response to capturing an image of the uniform resource locator embedded in the barcode.

15. A computing system, comprising:
a first computing device, including:
a first display device,
at least one first memory to store instructions, and
at least one first processor configured to execute the instructions stored in the
at least one first memory to perform operations, the operations comprising:
transmitting, to a server computing system, a request associated with a transaction between a first entity associated with the first computing device and a second entity,
receiving, from the server computing system, a barcode including encrypted transaction details information embedded in the barcode, the transaction details information being associated with completion of the transaction between the first entity and the second entity,
providing, for display by the first display device, the barcode and at least a portion of the transaction details information including one or more of a transaction time, first entity information, second entity information, a unique identifier associated with the second entity, status information, or an amount of the transaction.

16. The computing system of claim 15, further comprising a second computing device with which the second entity is associated, the second computing device including:
a second display device;
at least one second memory to store instructions; and
at least one second processor configured to execute the instructions stored in the at least one second memory to perform operations, the operations comprising:
capturing an image of the barcode provided for display by the first display device,
determining whether the barcode is authentic based on a decryption of the encrypted transaction details information embedded in the barcode,
providing, for display by the second display device, a first notification indicating the barcode is not authentic when a first hash value calculated based on the transaction details information is not equal to a second hash value calculated based on a digital signature used to digitally sign the transaction details information, and
providing, for display by the second display device, a second notification indicating the barcode is authentic when the first hash value calculated based on the transaction details information is equal to the second hash value calculated based on the digital signature used to digitally sign the transaction details information.

17. The computing system of claim 16, wherein
the barcode corresponds to a quick response code, and
the operations of the at least one second processor further comprise decrypting the encrypted transaction details information embedded in the barcode without an internet connection.

18. The computing system of claim 17, wherein decrypting the encrypted transaction details information embedded in the barcode without the internet connection includes decrypting the digital signature using a public key stored at the second computing device.

19. The computing system of claim 16, wherein
the barcode corresponds to a quick response code, and
the operations of the at least one second processor further comprise:
transmitting, to the server computing system, the image of the barcode, and
receiving, from the server computing system, a first indication that the barcode is not authentic when the server computing system determines the first hash value is not equal to the second hash value, and
receiving, from the server computing system, a second indication that the barcode is authentic when the server computing system determines the first hash value is equal to the second hash value.

20. The computing system of claim 19, wherein
a uniform resource locator is provided for display by the first display device separately from the barcode, and
transmitting, to the server computing system, the image of the barcode is in response to capturing an image of the uniform resource locator.
